(19) United States
(12) Patent Application Publication
(10) Pub. No.: US 2017/0063183 A1
(43) Pub. Date: Mar. 2, 2017

(54) ELECTRICAL MACHINES AND FABRICATION METHODS THEREFOR

(71) Applicant: ABB Technology AG, Zürich (CH)

(72) Inventors: Ghanshyam Shrestha, Apex, NC (US); Darren Tremelling, Apex, NC (US); George Q. Zhang, Windsor, CT (US); Thomas A. Fuhlbrigge, Ellington, CT (US); Remus Boca, Simsbury, CT (US); Jeremy Newkirk, Brookfield, IL (US)

(21) Appl. No.: 14/839,957

(22) Filed: Aug. 29, 2015

(51) Int. Cl. H02K 1/22; H02K 15/02; H02K 15/08; H02K 1/12

(52) U.S. Cl. CPC H02K 1/22; H02K 1/12; H02K 15/02; H02K 15/08

(57) ABSTRACT

An electrical machine includes a stator and a rotor in magnetic communication with the stator. The stator and/or the rotor include a unitary structure having a plurality of laminations and a plurality of spacing structures integral with the plurality of laminations. Each lamination of the plurality of laminations is disposed adjacent to another lamination of the plurality of laminations. Each spacing structure of the plurality of spacing structures is disposed between adjacent laminations, and is constructed to space the adjacent laminations apart from each other.

### FIELD OF THE DISCLOSURE

The present disclosure relates generally to electrical machines, and more particularly to electrical machines having a unitary rotating structure including a plurality of laminate layers spaced apart by spacing structures integrally formed together with a free form fabrication process, and/or a static structure including a plurality of laminate layers spaced apart by spacing structures integrally formed together with a free form fabrication process.

### BACKGROUND

Electrical machines having laminated rotors and/or stators remain an area of interest. Some existing systems have various shortcomings, drawbacks and disadvantages relative to certain applications. Accordingly, there remains a need for further contributions in this area of technology.

### SUMMARY

Embodiments of the present invention include a unique electrical machine. The electrical machine includes a stator and a rotor in magnetic communication with the stator. The stator and/or the rotor include a unitary structure having a plurality of laminations and a plurality of spacing structures integral with the plurality of laminations. Each lamination of the plurality of laminations is disposed adjacent to another lamination of the plurality of laminations. Each spacing structure of the plurality of spacing structures is disposed between adjacent laminations, and is constructed to space the adjacent laminations apart from each other.

In one aspect an electrical machine, comprising: a stator; and a rotor in magnetic communication with the stator, wherein one of the stator and the rotor include a unitary structure having a plurality of laminations and a plurality of spacing structures integral with the plurality of laminations, each lamination of the plurality of laminations disposed adjacent to another lamination of the plurality of laminations; and each spacing structure of the plurality of spacing structures being disposed between adjacent laminations and constructed to space the adjacent laminations apart from each other.

In another aspect a method for making an electrical machine, comprising: performing a first 3D printing to form a lamination for a rotor and/or a stator of the electrical machine; performing a second 3D printing to form a spacing structure for the rotor and/or the stator repeating the performing first 3D printing and the performing second 3D printing to generate a plurality of laminations and a plurality of spacing structures, wherein each lamination is disposed adjacent to another lamination; and wherein at least one spacing structure is disposed between adjacent laminations; and forming a unitary structure by sintering the laminations and the spacing structures together, wherein the laminations and spacing structures are integral with each other; and wherein the spacing structures are constructed to space adjacent laminations apart from each other.

In another aspect a method comprising: forming, with a free form fabrication process, a first lamination having a sintered layer of a first material; forming, with the free form fabrication process, a first spacing structure having a sintered layer of a second material such that the first spacing structure is integrally connected to and extends from the first lamination; repeating the forming of subsequent laminations and spacing structures to form a single unitary structure with a plurality of spaced apart laminations; and winding a conductive wire about the unitary structure to form a portion of an electrical machine.

### BRIEF DESCRIPTION OF THE DRAWINGS

The description herein makes reference to the accompanying drawings wherein like reference numerals refer to like parts throughout the several views, and wherein:

FIG. 1 schematically depicts some aspects of a non-limiting example of an electrical machine.

FIG. 2 schematically illustrates some aspects of a non-limiting example of a unitary structure in the form of a stator and a housing of an electrical machine.

FIG. 2A schematically illustrates one non-limiting example of a transverse flux machine with both radial and axial flux path.

FIG. 3 schematically illustrates some aspects of a non-limiting example of a unitary structure in the form of a rotor and shaft of an electrical machine.

FIG. 4 schematically illustrates some aspects of a non-limiting example of a lamination and a spacing structure for a rotor of an electrical machine.

FIG. 5 schematically illustrates some aspects of a non-limiting example of a unitary structure in the form of a rotor and shaft of an electrical machine.

FIG. 6 is a magnified view schematically illustrating some aspects of a non-limiting example of a lamination and a spacing structure for a rotor or a stator of an electrical machine.

### DETAILED DESCRIPTION

For purposes of promoting an understanding of the principles of the electrical machines and methods discloses herein, reference will now be made to the examples illustrated in the drawings, and specific language will be used to describe the same. It will nonetheless be understood that no limitation of the scope of the invention is intended by the illustration and description of certain examples of the invention. In addition, any alterations and/or modifications of the illustrated and/or described example(s) are contemplated as being within the scope of the present invention. Further, any other applications of the principles of the invention, as illustrated and/or described herein, as would normally occur to one skilled in the art to which the invention pertains, are contemplated as being within the scope of the present invention.

The present disclosure is directed to an electrical machine having a rotating structure and/or a static structure that is formed as a single unitary structure through a free form fabrication process or with material additive techniques such as laser deposition, stereo lithography, or 3D printing to name just a few examples. It should be noted that when the term “laminate”, “laminated”, “lamination” or similar descriptions are used herein, that it is representative of a portion of a structure that is formed by one or more layers of sintered material. In some embodiments it does not connote a separately formed component that is subsequently positioned adjacent to and/or affixed to another separately formed component. In some embodiments the lamination portions described herein are integrally formed and connected together with spacer portions to form a single integral structure by way of a free form fabrication process as will be explained in detail below.

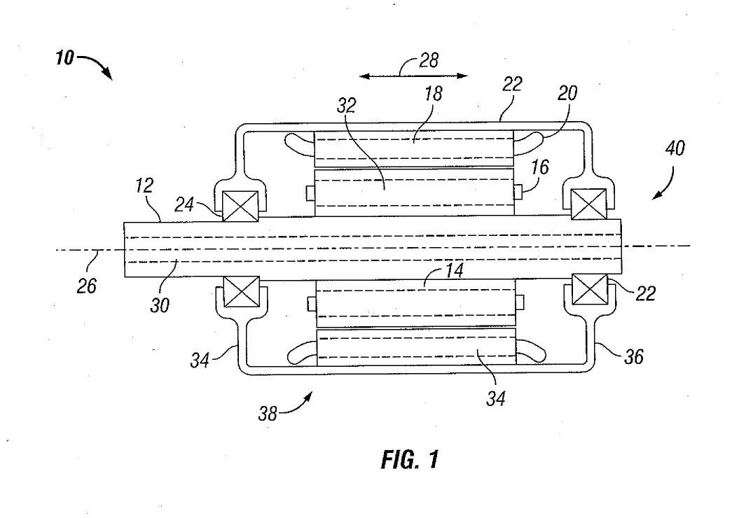

Referring to the drawings, and in particular FIG. 1, some aspects of a non-limiting example of an electrical machine 10 in accordance with an embodiment of the present invention are schematically depicted. In one form, electrical machine 10 is an induction machine. In other embodiments, electrical machine 10 may be a motor and/or a generator, and may be any asynchronous, synchronous or switched machine such as a reluctance motor, or any other type of motor, generator or motor/generator. In various embodiments, electrical machine 10 may be a radial flux machine, an axial flux machine or a machine having a three-dimensional (3D) flux (transverse flux machine). Electrical machine 10 includes a shaft 12, a rotor 14 having rotor conductors 16, a stator 18 having stator windings 20, a housing 22 and bearings 24. Shaft 12 and rotor 14 rotate about an axis of rotation 26, which defines an axial direction 28.

In one form, electrical machine 10 does not employ a commutator. In other embodiments, electrical machine 10 may employ a commutator. Shaft 12 is constructed to support rotor 14 and react radial and axial or thrust loads from rotor 14. In one form, shaft 12 is operative to transmit mechanical power from electrical machine 10 as an output of machine 10. In other embodiments, shaft 12 may be operative to transmit power to and/or from electrical machine 10. Shaft 12 is axially and radially positioned by bearings 24. Shaft 12 and bearings 24 define axis of rotation 26 and corresponding axial direction 28. Shaft 12 and rotor 14 are operable to rotate about axis of rotation 26. In some embodiments, shaft 12 may be hollow, e.g., may include a cavity or passage 30 extending all or partway through shaft 12, e.g., in order to reduce weight and/or provide a flowpath for a cooling medium for removing heat from rotor 14 and or stator 18.

Rotor 14 and stator 18 are in magnetic communication with each other. Each of rotor 14 and stator 18 have a construction that is operative to direct magnetic flux to and from each other. Rotor conductors 16 may be bus bars, windings or both, or may take other forms. In some embodiments, permanent magnets and/or permanent magnetic material may be used in conjunction with, as part of, or in place of rotor conductors 16. Rotor conductors 16 are disposed within passages 32 in rotor 14. In one form, passages 32 are linear, and extend through the length of rotor 14. In other embodiments, passages 32 may be radial passages or may be passages having a centerline that extends in two or more of axial, radial and circumferential directions through all or only part of rotor 14, including helically or skew in relation to axis of rotation 26. In some embodiments, rotor 14 may include other passages in addition to passages 32, e.g., cooling passages or other passages. In some embodiments, passages 32 may be structured to allow a flow of a cooling medium therethrough.

Stator windings 20 are disposed within passages 34 in stator 18. Stator windings 20 may be, for example, copper and/or aluminum. In other embodiments, other materials may be used in addition to or in place of copper and/or aluminum. In some embodiments stator windings 20 may be cast in a mold, e.g., a permanent ceramic mold that may act, for example, as the insulation between the stator windings and the stator lamination structure. In one form, passages 34 are linear, and extend through the length of stator 18 in substantially axial direction 28. In another form the passages 34 are linear and extend through the length of the stator in an axial direction. In other embodiments, passages 34 may be radial passages or may be passages having a centerline that extends in two or more of axial, radial and circumferential directions through all or part of stator 18, including helically or skew in relation to axis of rotation 26. In some embodiments, stator 18 may include other passages in addition to passages 34, e.g., cooling passages or other passages. In some embodiments, passages 34 may be structured to allow a flow of a cooling medium therethrough.

In one form, bearings 24 are mounted in and supported by end plates 36 of housing 22. In other embodiments, bearings 24 may be mounted and coupled to housing 22 via one or more other structures and/or integral features of housing 22. Bearings 24 are structured to react shaft 12 and rotor 14 axial or thrust loads in direction 28, and to react shaft 12 and rotor 14 radial loads that are perpendicular to axis of rotation 26. Housing 22 is constructed to enclose stator 18 and react loads associated with stator 18, e.g., loads generated due to magnetic interaction between stator 18 and rotor 14.

Embodiments of electrical machine 10 include unitary structures 38 and 40. A unitary structure, as that term is used herein, is a structure wherein all of the structural features of such structure are integral with each other. As used herein, “integral” does not mean attached to, affixed to, or the like, e.g., bolted to, welded to, brazed to, bonded to or the like, but rather, means that the different geometric and structural features that define the unitary structure are formed together as features of a single, continuous, undivided structure, as opposed to previously formed or otherwise manufactured components that are assembled together or otherwise joined or affixed together using one or more of various joining means to yield a final assembled product.

In one form, unitary structures 38 and 40 are formed by an additive manufacturing process through one or more free form fabrication techniques as would be known to one skilled in the art. In various embodiments, other additive manufacturing techniques may be employed in addition to or in place of laser sintering, e.g., laser powder forming, an example of which is Laser Engineered Net Shaping (LENS), a proprietary name and trademark of Sandia National Labs. and Sandia Corp. Other suitable additive manufacturing techniques include electron beam melting and/or one or more of various stereo lithography techniques, or other techniques not mentioned herein. In various embodiments, the 3D-printed unitary structures 38 and 40 may be net shape or near net shape, and may or may not require finishing treatments, depending upon the particular application. One laser sinter machine that can be used to produce unitary rotatable and static structures is commercially available from EOS of North America, Inc. of Novi, Mich., USA.

In one form, unitary structures 38 and 40 are formed by a laser sintering method of 3D printing, wherein layers of powdered material, such as powdered electrical steel, are selectively sintered to achieve a desired shape, e.g., a cross-sectional shape of one or more of shaft 12, rotor 14, stator 18 and housing 22. Once a first layer is sintered, another layer of powdered material is deposited over it, and the selective sintering process is repeated for the same or a different shape. This second sintering process both sinters the second layer together to solidify it, and also sinters it to one or more previous layers. In this manner, the laser sintering method of 3D printing may be used to create unitary, integral structures, such as one or more of shaft 12, rotor 14, stator 18 and housing 22. For example, in one embodiment, shaft 12 and rotor 14 may be formed together, e.g., simultaneously, using the laser sintering method of 3D printing to yield a unitary, integral structure. In another embodiment, rotor 14 may be a unitary and integral structure to which shaft 12 is affixed. Similarly, in yet another embodiment, stator 18 and housing 22 may be formed together, e.g., simultaneously, using the laser sintering method of 3D printing to yield a unitary, integral structure. In still another embodiment, stator 18 may be a unitary and integral structure, which is affixed to housing 22.

Although the housing is illustrated as a solid hollow cylinder, the housing can have fins, can be shaped so that it comes in close contact with the end windings in order to reduce temperature rise of the windings. Similarly the housing can be made like a lattice or foamed type structure so that air can flow through the end region and providing limited ingress protection (IP21).

Similarly, a mesh or foam like structure could also be utilized on the rotor side as a majority of the shaft to allow for coolant flow to and through to heat dissipative regions of the machine. For reduction in printed mass, the shaft would appear as a meshed structure at a large radius, and still result in similar or better stiffness compared to present shafts.

In one form, unitary structure 38 includes rotor 14 and shaft 12. In other embodiments, unitary structure 38 may include only rotor 14, e.g., wherein rotor 14 is unitary structure 38. In one form, unitary structure 40 includes both stator 18 and housing 22. In other embodiments, unitary structure 40 may include only stator 18, e.g., wherein stator 18 is unitary structure 40. In some embodiments, rotor 14 and/or shaft 12 and/or stator 18 and/or housing 22 are formed simultaneously by a material additive manufacturing process such as one implemented by the 3D printing machine. Such a technique may allow the use of a smaller 3D printing machine or allow multiple quantities of rotor 14 and/or shaft 12 and/or stator 18 and/or housing 22 to be formed in a given printing machine, given that in some embodiments, stator 18 is disposed radially inward of housing 22; rotor 14 is disposed radially inward of stator 18; and shaft 12 is disposed radially inward of the outer extents of rotor 14.

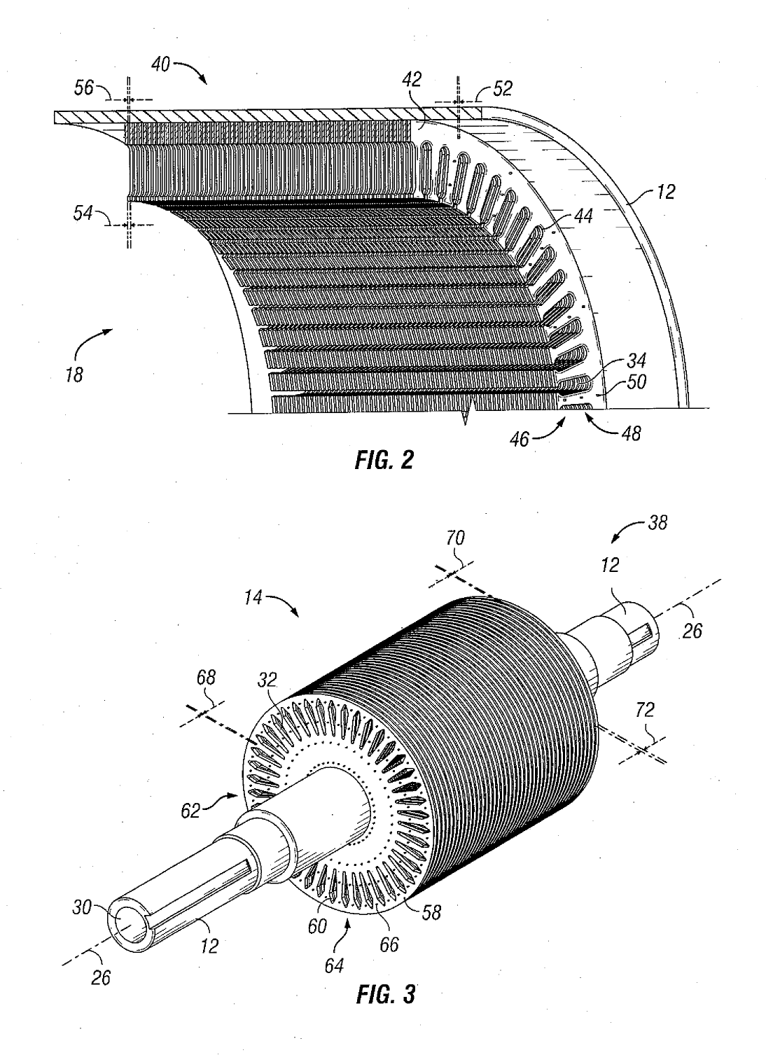

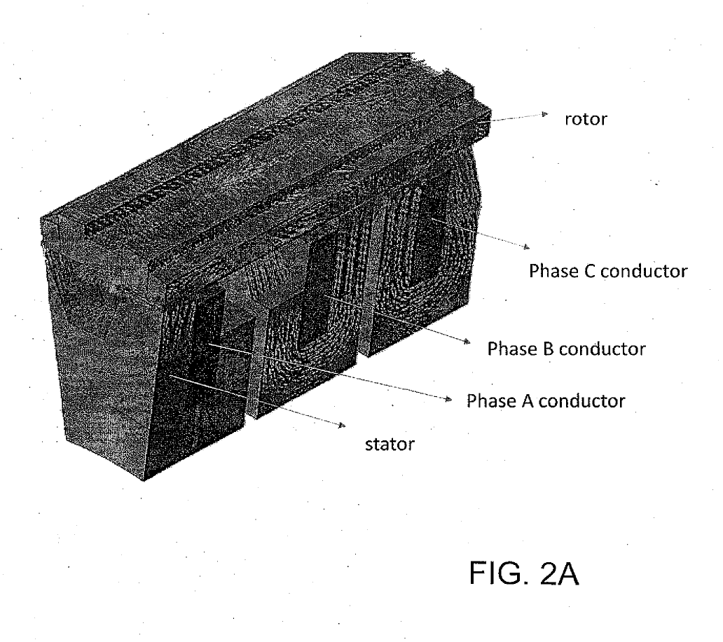

Referring to FIG. 2, some aspects of a non-limiting example of stator 18 and housing 22 in accordance with an embodiment of the present invention are schematically depicted. Stator 18 is disposed within housing 22, and in some embodiments is integral with housing 22. Stator 18 includes a plurality of laminations 42. Each lamination 42 includes a plurality of openings 44, which are aligned to form passages 34. Each lamination 42 is spaced apart from an adjacent lamination 42 by a spacing structure 46. Laminations 42 are integral with spacing structures 46, and together, laminations 42 and spacing structures 46 define a unitary structure, e.g., all or part of unitary structure 40. Laminations 42 are geometrically constructed to direct magnetic flux to rotor 14, and to receive magnetic flux directed to lamination 42 from rotor 14. That is to say, laminations 42 are operative to provide a flux path directed to rotor 14 that extends in a direction toward rotor 14, and a flux path extending in a direction from rotor 14 toward stator 18 to transmit magnetic flux to rotor 14 and receive magnetic flux from rotor 14.

In one form, laminations 42 are disc-shaped, and are spaced apart in the axial direction 28. In other embodiments, laminations 42 may be U-shaped or have another geometry, and may be stacked together in the radial direction perpendicular to axial direction 28, and/or the circumferential direction corresponding to rotation about axis of rotation 26. In some embodiments, one or more of laminations 42 may be of non-uniform thickness, e.g., where the thickness of one or more of lamination 42 varies along one or more of the axial, radial and circumferential directions. For example, in some embodiments, one or more of laminations 42 may be thinner at a minimum lamination 42 diameter, e.g., at the air gap between rotor 14 and stator 16, and may become progressively thicker with increasing radial distance from the air gap. In some embodiments, some or all laminations 42 may be formed parallel to a plane, e.g., a plane that is perpendicular to axial direction 28, whereas in other embodiments, some or all of laminations 42 may be formed at an angle to the plane, which may, in some embodiments increase structural integrity, e.g., while printing. In some embodiments, laminations 42 may be helical, e.g., a continuous helical structure akin to the helical form of a spring. In some embodiments, laminations, such as laminations 42, may be integrated into housing 22, which in some embodiments may yield a reduction in thermal resistance. In a normal machine where the stator laminations are shrunk fitted to the machine, there is a thermal resistance between the housing and stator lamination. When the housing and the lamination are built together, this thermal resistance is not present anymore, therefore allowing for a more effective thermal path from the lamination to the housing and convected from the housing. The reduction in thermal resistance compared to presently constructed machines would be due to the elimination of the interface between stator laminations and housing, due to ability to print housing at same time at stator laminations, removing potential of small airgap between distinct parts.

Spacing structures 46 have a geometry that is configured to reduce eddy currents between laminations 42. Any suitable geometry may be employed. In one form, spacing structures 46 and laminations 42 may be formed of electrical steel, e.g., in the form of sintered powdered electrical steel. In other embodiments, other materials may be employed. In some embodiments, spacing structures 46 and laminations 42 may be formed of different materials. For example, laminations 42 may be formed of sintered powdered electrical steel, whereas spacing structures 46 may be formed of another material or combination of materials, e.g., a material having a higher electrical resistance than the electrical steel or other material used to form laminations 42, such as nichrome or stainless steel powder that may be used in the laser sintering method of 3D printing, which may further reduce eddy currents between laminations 42 in some embodiments. As another example, spacing structures 46 may be formed of insulating materials, such as a ceramic material, a polymeric material and/or other insulating materials. The plane means that an insulation layer can be added on the whole surface not only as spacing structures as we did with electrical steel. In some embodiments, spacing, e.g., between laminations 42, may be modified (e.g., as between applications) or selected in order to reduce harmonic shorting effects. In still other embodiments, cladding may be placed on desired surfaces, e.g., on the surface of laminations 42 and/or all or part of spacing structure 46, e.g., in order to limit the penetration of loss inducing harmonics. For the sake of clarity the present application contemplates that in at least one embodiment the cladding of the printed surface to span the spacing structure.

In one form, one or more spacing structures 46 are in the form of a spacing grid 48, that is, a plurality of standoffs 50 arranged in the form of a grid or pattern. In one form, standoffs 50 are solid cylinders having a diameter of approximately 0.5 mm and a length 52 in axial direction 28 of 0.5-100 μm, which yields a spacing 56 of 0.5-100 μm between adjacent laminations 42. In other embodiments, the dimensions of spacing structures 46, spacing grids 48 and standoffs 50 may vary with the needs of the application. In various embodiments, the thickness of laminations 42 may be less than, equal to or greater than the length of the standoffs 50. For example, in one embodiment, laminations 42 have a thickness 54 of 200 μm in axial direction 28. Standoffs 50 may take other forms in other embodiments, e.g., hollow cylinders, circular or otherwise, or any other suitable shape, solid or hollow. In some embodiments, standoffs 50 all have the same shape, but in other embodiments, the shape of standoffs 50 may vary on any given lamination 42 or as between different laminations 42. Standoffs 50 are integral with each adjacent lamination.

In some embodiments, each spacing structure 46, or standoff 50 for embodiments so equipped, is aligned radially and circumferentially with the other spacing structures 46 or standoffs 50, thereby providing lines of continuous and integral structure, e.g., sintered electrical steel and/or one or more other solidified materials, from one end of stator 18 to the other end of stator 18 in the axial direction 28, which may increase the stiffness of stator 18 in some embodiments. In other embodiments, one or more features of a desired number of spacing structures 46 may be shifted out of alignment, e.g., in order to achieve some desired effect, e.g., a tuned stiffness. In some embodiments, an insulator, e.g., resin, may be disposed between adjacent laminations 58, e.g., by impregnation after the formation of stator 18. The spacing can also be optimized for micro channel cooling with either air or other fluids. With a defined path for fluid flow it is expected that the power required to push a fluid through the micro channels will be lower than conventional micro channels. The size and shape of these channels may be arranged to result in optimal cooling for limited pressure drop(s), such that the cooling channels follow a philosophy commonly known as constructural design.

In some embodiments for the transverse flux machine with a 3D flux path, the flux path can be controlled along the radial and axial direction. A transverse flux machine has both radial and axial flux path. With 3D printing, it is easier to construct such machines so that the flux path along radial and axial directions can be controlled without much difficulty. It is very difficult to have such construction with conventional lamination sheet for construction, as the lamination as it known today comes in a planar form. FIG. 2A is provided to assist illustrating the above material contemplated by the present application.

The lamination can be shaped with curved structure with various material densities and thicknesses so that the magnetic flux along the radial and axial directions can be controlled at ease. Typically, parts of transverse flux machines are fabricated of bulk components of solid soft magnetic material or of compressed parts of powdered soft magnetic material (Hoganas Somaloy). These materials are isotropic and either alloy for significant eddy current losses (solid steel) or of limited magnetic permeability (Somaloy). Also, these materials do not channel the magnetic flux to flow in preferred directions, resulting in greater leakage flux than possible with arbitrarily shaped laminations.

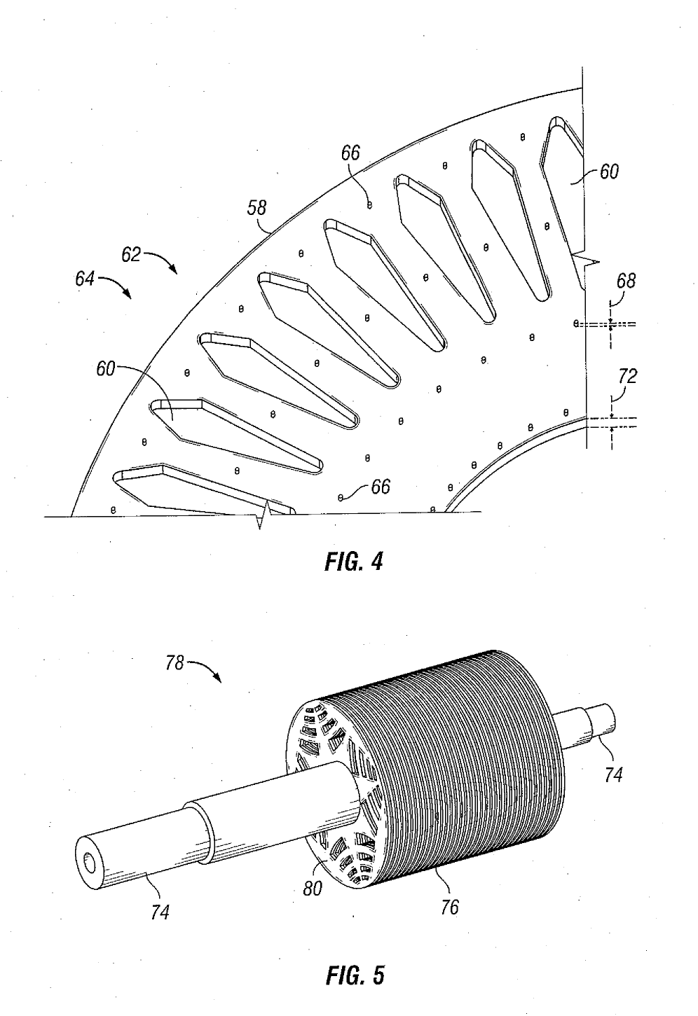

Referring to FIGS. 3 and 4, some aspects of a non-limiting example of shaft 12 and rotor 14 in accordance with an embodiment of the present invention are schematically depicted. In one form, shaft 12 is integral with rotor 14. In other embodiments, shaft 12 may not be integral with rotor 14, but rather may be coupled to or affixed to rotor 14, e.g., via an interference fit, brazing, bonding, welding or other joining means. Rotor 14 includes a plurality of laminations 58. Each lamination 58 includes a plurality of openings 60, which are aligned so as to form passages 32. Each lamination 58 is spaced apart from an adjacent lamination 58 by a spacing structure 62. Laminations 58 are integral with spacing structures 62, and together, laminations 58 and spacing structures 62 define a unitary structure, e.g., all or part of unitary structure 38. Laminations 58 are geometrically constructed to direct magnetic flux to stator 18, and to receive magnetic flux directed to lamination 58 from stator 18. That is to say, laminations 58 are operative to provide a flux path directed to stator 18 that extends toward stator 18, and a flux path extending from stator 18 toward rotor 14, to transmit magnetic flux to stator 18 or receive magnetic flux from stator 18. In one form, laminations 58 are disc-shaped, and are spaced apart in the axial direction 28. In other embodiments, laminations 58 may be U-shaped or have another geometry, and may be stacked together in the radial direction perpendicular to axial direction 28, and/or the circumferential direction corresponding to rotation about axis of rotation 26.

Spacing structures 62 have a geometry that is configured to reduce eddy currents between laminations 58. Any suitable geometry may be employed. In one form, spacing structures 62 and laminations 58 are formed of electrical steel, e.g., in the form of sintered powdered electrical steel. In other embodiments, other materials may be employed. In some embodiments, spacing structures 62 and laminations 58 may be formed of different materials. For example, laminations 58 may be formed of sintered powdered electrical steel, whereas spacing structures 62 may be formed of another material or combination of materials, e.g., a material having a higher electrical resistance than the electrical steel or other material used to form laminations 58, such a nichrome or stainless steel powder that may be used in the laser sintering method of 3D printing, which may further reduce eddy currents between laminations 58 in some embodiments. In other embodiments, spacing structures 62 may be formed of ceramic and/or polymeric materials.

In one form, one or more spacing structures 62 are in the form of a spacing grid 64, that is, a plurality of standoffs 66 arranged in the form of a grid or pattern. In one form, standoffs 66 are solid cylinders having a diameter of approximately 0.5 mm and a length 68 in axial direction 28 of 0.5-100 μm, which yields a spacing 70 of 0.5-100 μm between adjacent laminations 58. In other embodiments, the dimensions of spacing structures 62, spacing grids 64 and standoffs 66 may vary with the needs of the application. In various embodiments, the thickness of laminations 58 may be less than, equal to or greater than the length of the standoffs 66. For example, in one embodiment, laminations 58 have a thickness 72 of 200 μm in axial direction 28. Standoffs 66 may take other forms in other embodiments, e.g., hollow cylinders or any other suitable shape, solid or hollow. In some embodiments, standoffs 66 all have the same shape, but in other embodiments, the shape of standoffs 66 may vary on any given lamination 58 or as between different laminations 58. Standoffs 66 are integral with each adjacent lamination 58.

In some embodiments, each spacing structure 62, or standoff 66 for embodiments so equipped, is aligned radially and circumferentially with the other spacing structures 62 or standoffs 66, thereby providing lines of continuous and integral structure, e.g., sintered electrical steel and/or one or more other solidified materials, from one end of rotor 14 to the other end of rotor 14 in the axial direction 28, which may increase the stiffness of rotor 14 in some embodiments. In other embodiments, one or more features of a selected number of spacing structures 62 may be shifted out of alignment, e.g., in order to achieve some desired effect, e.g., a tuned stiffness. In some embodiments, an insulator, e.g., resin, may be disposed between adjacent laminations 58, e.g., by impregnation after the formation of rotor 14.

Referring to FIG. 5, some aspects of a non-limiting example of a shaft 74 and a rotor 76 of an electrical machine 78 in accordance with an embodiment of the present invention are schematically depicted. Electrical machine 78 is a synchronous reluctance motor. Rotor 76 is a unitary and integral structure that includes a plurality of laminations 80 spaced apart by spacing structures (not shown) in a manner similar to that of rotor 14.

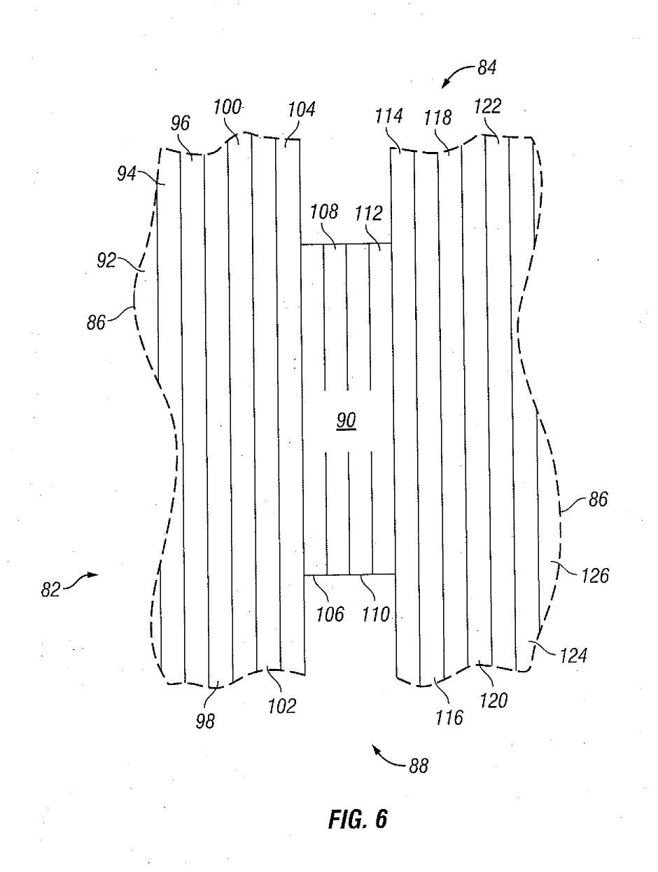

Referring to FIG. 6, some aspects of a non-limiting example of a lamination structure 82 in accordance with an embodiment of the present invention are schematically depicted. Lamination structure 82 may be all or part of any electrical machine 84 rotor or stator. For example, one or more lamination structures 82 may form all or part of rotor 14, stator 18 or rotor 76. Lamination structure 82 is a unitary and integral structure. Lamination structure 82 includes a plurality of laminations 86, only portions of two of which are illustrated, Lamination structure 82 also includes a plurality of spacing structures 88, e.g., each of which is in the form of a plurality standoffs 90, only one of which is illustrated. Spacing structures 88 are constructed to space laminations 86 apart from each other in a manner similar to that described above with respect to rotor 14 and stator 18. As with rotor 14 and stator 18, each spacing structure 88 is integral with the adjacent laminations 86 between which it is disposed.

In accordance with some embodiments of the present invention, lamination structure 82, and by way of example, shaft 12, rotor 14, stator 18, housing 22, shaft 74 and rotor 76 are formed layer by layer via a desired additive manufacturing process, e.g., 3D printing system or stereo lithography system or the like. In some embodiments, some or all laminations 86 may be formed parallel to a plane, e.g., a plane that is perpendicular to axial direction 28, whereas in other embodiments, some or all of laminations 86 may be formed at an angle to the plane, which may, in some embodiments increase structural integrity, e.g., while printing. In some embodiments, laminations 86 may be helical, e.g., a continuous helical structure akin to the helical form of a spring. For example, in some embodiments, 3D printing is performed to form a plurality of laminations 86 for a rotor and/or a stator of electrical machine 84; and 3D printing is performed to form a plurality of spacing structures 88 for the rotor and/or the stator. The 3D printing may be performed using, for example, a laser sintering machine. The 3D printing of the laminations 86 and the spacing structures 88 is repeated, e.g., alternatingly, to generate a plurality of laminations 86 and a plurality of spacing structures 88, wherein each lamination 86 is disposed adjacent to another lamination 86; and wherein a spacing structure 88 is disposed between adjacent laminations 86, and constructed to space apart the adjacent laminations 86. A unitary structure, e.g., a lamination structure that forms all or part of one or more of rotor 14, stator 18, rotor 76, may be formed by successively sintering a plurality of layers of powdered material to form the geometry of laminations 86 and spacing structures 88 as an integral structure.

The 3D printing process includes successively sintering a plurality of lamination layers to each other, e.g., layers 92, 94, 96, 98, 100, 102 and 104, wherein a first such layer is formed by depositing powered material, e.g. powered electrical steel, and selectively sintering the powered material together to achieve a desired cross section or layer thickness. The sintering step both solidifies the powder at desired locations, and sinters the powdered material at selected locations to a previously sintered layer. The process of depositing and sintering is successively repeated until the desired structure, e.g., a lamination 86, is achieved. The sequence is repeated as required to form the first lamination 86 with a desired thickness. Subsequently, a first layer 106 of standoffs 90 of spacing structure 88 is deposited onto the first lamination 86 and sintered together and sintered to the first lamination 86. Subsequent layers of spacing structure 88, e.g., layers 108, 110 and 112, are successively and likewise deposited and sintered to form the first spacing structure 88 integral with first lamination 86. Upon completion of the spacing structure 88, a first layer 114 of a second lamination 86 is deposited onto the first spacing structure 88 and sintered together and sintered to the first spacing structure 88. Subsequent layers of the second lamination 86, e.g., layers 116, 118, 120, 122, 124 and 126, are successively and likewise deposited and sintered to form the second lamination 86. The process is repeated a desired number of times in order to yield the desired number of laminations 86 and corresponding spacing structures 88 to yield a unitary and integral lamination structure 82. It will be understood that, although the above description mentions depositing and sintering layers of lamination 86 prior to depositing and sintering layers of spacing structures 88, other embodiments may alternatively initiate the 3D printing process by depositing and sintering layers of spacing structures 88, followed by depositing and sintering layers of laminations 88. In like manner as that described above for lamination structures such as rotor 14, stator 18 or rotor 76, other structures may be similarly formed, layer by layer, alone or integrally with rotor 14, stator 18 or rotor 76, e.g., shaft 12, housing 22 and shaft 74, respectively, by successively depositing and sintering layers of material, e.g., powdered electrical steel.

Embodiments of the present invention include an electrical machine, comprising: a stator; and a rotor in magnetic communication with the stator, wherein one of the stator and the rotor include a unitary structure having a plurality of laminations and a plurality of spacing structures integral with the plurality of laminations, each lamination of the plurality of laminations disposed adjacent to another lamination of the plurality of laminations; and each spacing structure of the plurality of spacing structures being disposed between adjacent laminations and constructed to space the adjacent laminations apart from each other.

In a refinement, the electrical machine further comprises a shaft formed as part of the unitary structure, wherein the shaft is integral with the rotor.

In another refinement, the shaft is hollow.

In yet another refinement, some of the laminations include openings therethrough that form passages extending at least partway through the unitary structure.

In still another refinement, the electrical machine further comprises windings disposed within some of the passages.

In yet still another refinement, one of the spacing structures is a spacing grid having a plurality of standoffs integral with and extending between each adjacent lamination.

In a further refinement, the spacing structures have a geometry constructed to reduce eddy currents between the laminations.

In a yet further refinement, the spacing structures and the laminations are formed from the same material.

In a still further refinement, the spacing structures are formed of a first material; and wherein the laminations are formed of a second material different from the first material.

In a yet still further refinement, the first material has a higher electrical resistance than the second material.

In an additional refinement, the unitary structure is formed of a sintered material.

In an additional refinement, the electrical machine further comprises a housing formed as part of the unitary structure and the housing is integral with the rotor.

In a yet further refinement, the unitary structure has characteristics consistent with fabrication by 3D printing

Embodiments of the present invention include method for making an electrical machine, comprising: performing first 3D printing to form a lamination for a rotor and/or a stator of the electrical machine; performing second 3D printing to form a spacing structure for the rotor and/or the stator; repeating the performing first 3D printing and the performing second 3D printing to generate a plurality of laminations and a plurality of spacing structures, wherein each lamination is disposed adjacent to another lamination; and wherein at least one spacing structure is disposed between adjacent laminations; and forming a unitary structure by sintering the laminations and the spacing structures together, wherein the laminations and spacing structures are integral with each other; and wherein the spacing structures are constructed to space adjacent laminations apart from each other.

In a refinement, the performing first 3D printing includes successively sintering a plurality of lamination layers to each other to form a first lamination.

In another refinement, the performing first and second 3D printing further includes: (a) sintering a first spacing structure layer of a first spacing structure, including sintering the first spacing structure layer to the first lamination; (b) successively sintering subsequent spacing structure layers to previous spacing structure layers a predetermined number of times to form the first spacing structure; (c) sintering a first lamination layer of a second lamination, including sintering the first lamination layer of the second lamination to the first spacing structure; (d) successively sintering subsequent lamination layers to previous spacing structure layers a predetermined number of times to form the second lamination; and (e) repeating acts (a) through (d) to form a predetermined number of laminations and spacing structures of the unitary structure.

In yet another refinement, the 3D printing comprises a laser sintering process.

In still another refinement, the method further comprises performing third 3D printing to form a shaft integral with the rotor.

In yet still another refinement, the method further comprises performing a fourth 3D printing to form the housing.

In a further refinement, the method further comprises the housing is formed simultaneously with the rotor and/or the stator.

In a yet further refinement, the method further comprises simultaneously forming the rotor and the stator.

Embodiments of the present invention include an electrical machine, comprising: means for directing magnetic flux; and means for reducing eddy currents in the means for directing, wherein the means for reducing is integral with the means for directing, and forms a unitary structure with the means for directing.

Embodiments of the present invention include a method comprising: forming, with a free form fabrication process, a first lamination having a sintered layer of a first material; forming, with the free form fabrication process, a first spacing structure having a sintered layer of a second material such that the first spacing structure is integrally connected to and extends from the first lamination; repeating the forming of subsequent laminations and spacing structures to form a single unitary structure with a plurality of spaced apart laminations; and winding a conductive wire about the unitary structure to form a portion of an electrical machine.

In a refinement, the unitary structure is a rotatable component.

In another refinement, the first material is the same as the second material.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An electrical machine, comprising:
a stator; and
a rotor in magnetic communication with the stator,
wherein one of the stator and the rotor include a unitary structure having a plurality of laminations and a plurality of spacing structures integral with the plurality of laminations, each lamination of the plurality of laminations disposed adjacent to another lamination of the plurality of laminations; and each spacing structure of the plurality of spacing structures being disposed between adjacent laminations and configured to space the adjacent laminations apart from each other.

2. The electrical machine of claim 1, further comprising a shaft formed as part of the unitary structure, wherein the shaft is integral with the rotor.

3. The electrical machine of claim 2, wherein the shaft is hollow.

4. The electrical machine of claim 1, wherein some of the laminations include openings therethrough that form passages extending at least partway through the unitary structure.

5. The electrical machine of claim 4, further comprising windings disposed within some of the passages.

6. The electrical machine of claim 1, wherein one of the spacing structures is a spacing grid having a plurality of standoffs integral with and extending between each adjacent lamination.

7. The electrical machine of claim 1, wherein the spacing structures have a geometry configured to reduce eddy currents between the laminations.

8. The electrical machine of claim 1, wherein the spacing structures and the laminations are formed from the same material.

9. The electrical machine of claim 1, wherein the spacing structures are formed of a first material; and wherein the laminations are formed of a second material different from the first material.

10. The electrical machine of claim 9, wherein the first material has a higher electrical resistance than the second material.

11. The electrical machine of claim 1, wherein the unitary structure is formed of a sintered material.

12. The electrical machine of claim 1, further comprising a housing formed as part of the unitary structure, wherein the housing is integral with the stator.

13. The electrical machine of claim 1, wherein the unitary structure has characteristics consistent with fabrication by 3D printing.

14. The electrical machine of claim 1, further comprising a shaft formed as part of the unitary structure, wherein the shaft is integral with the rotor;
wherein some of the laminations include openings therethrough that form passages extending at least partway through the unitary structure;
further comprising windings disposed within some of the passages;
wherein one of the spacing structures is a spacing grid having a plurality of standoffs integral with and extending between each adjacent lamination; and
wherein the unitary structure material properties are consistent with a structure formed by 3D printing.

15. A method for making an electrical machine, comprising:
performing a first 3D printing to form a lamination for a rotor and/or a stator of the electrical machine;
performing a second 3D printing to form a spacing structure for the rotor and/or the stator;
repeating the performing first 3D printing and the performing second 3D printing to generate a plurality of laminations and a plurality of spacing structures, wherein each lamination is disposed adjacent to another lamination; and wherein at least one spacing structure is disposed between adjacent laminations; and
forming a unitary structure by sintering the laminations and the spacing structures together, wherein the laminations and spacing structures are integral with each other; and wherein the spacing structures are constructed to space adjacent laminations apart from each other.

16. The method of claim 15, wherein the performing first 3D printing includes successively sintering a plurality of lamination layers to each other to form a first lamination.

17. The method of claim 16, wherein the performing first and second 3D printing further includes:
(a) sintering a first spacing structure layer of a first spacing structure, including sintering the first spacing structure layer to the first lamination;
(b) successively sintering subsequent spacing structure layers to previous spacing structure layers a predetermined number of times to form the first spacing structure;
(c) sintering a first lamination layer of a second lamination, including sintering the first lamination layer of the second lamination to the first spacing structure;
(d) successively sintering subsequent lamination layers to previous spacing structure layers a predetermined number of times to form the second lamination; and
(e) repeating acts f (a) through (d) to form a predetermined number of laminations and spacing structures of the unitary structure.

18. The method of claim 15, wherein the 3D printing comprises a laser sintering process.

19. The method of claim 15, further comprising performing third 3D printing to form a shaft integral with the rotor.

20. The method of claim 15, further comprising performing fourth 3D printing to form a housing.

21. The method of claim 20, wherein the housing is formed simultaneously with the rotor and/or the stator.

22. The method of claim 15, further comprising simultaneously forming the rotor and the stator.

23. A method comprising:
forming, with a free form fabrication process, a first lamination having a sintered layer of a first material;
forming, with the free form fabrication process, a first spacing structure having a sintered layer of a second material such that the first spacing structure is integrally connected to and extends from the first lamination;
repeating the forming of subsequent laminations and spacing structures to form a single unitary structure with a plurality of spaced apart laminations; and
winding a conductive wire about the unitary structure to form a portion of an electrical machine.

24. The method of claim 23, wherein the unitary structure is a rotatable component.

25. The method of claim 23, wherein the first material is the same as the second material.
